(19) United States
(12) Patent Application Publication
(10) Pub. No.: US 2022/0343082 A1
(43) Pub. Date: Oct. 27, 2022

(54) SYSTEM AND METHOD FOR ENSEMBLE QUESTION ANSWERING

(71) Applicant: SALTLUX INC., Seoul (KR)

(72) Inventor: Kyung Il LEE, Seoul (KR)

(21) Appl. No.: 17/641,385

(22) PCT Filed: Oct. 17, 2019
(86) PCT No.: PCT/KR2019/013642

§ 371 Date: Mar. 8, 2022

(30) Foreign Application Priority Data
Sep. 9, 2019 (KR) 10-2019-0111550

(51) Int. Cl. G06F 40/40; G06F 40/30; G06F 40/284; G06N 5/02; G06F 16/9535

(52) U.S. Cl. CPC G06F 40/40; G06F 40/30; G06F 40/284; G06N 5/02; G06F 16/9535

(57) ABSTRACT

This application relates to a system and method for ensemble question-answering. In one aspect, the system may include a user interface that receives a question input and provides an answer output, and a deep learning network trained to select at least one question-answering engine suitable for a question from among a plurality of question-answering engines. The system may also include a model detection unit that provides the question input and semantic data of the question input to the deep learning network, and receives at least one index corresponding to at least one question-answering engine from the deep learning network. The system may further include an answer generation unit that provides the question input to the at least one question-answering engine and generates the answer output by receiving an answer from the at least one question-answering engine.

### TECHNICAL FIELD

The technical idea of the present invention relates to automatic question-answering, and more particularly, to a system and method for ensemble question-answering.

The present invention is derived from research conducted and supervised by Saltlux Co., Ltd. as part of the SW Computing Source Technology Development Project (SW) of the Ministry of Science, ICT and Future Planning. [Research period: Jan. 1, 2019 to Dec. 31, 2019, Research and management specialized institutions: Information and Communication Technology Promotion Center, Research project name: WiseKB: Development of self-learning knowledge base and reasoning technology based on big data understanding, Assignment identification number: 2013-0-00109]

### BACKGROUND ART

A user question may have various forms, such as a form of questioning the object of interest, a form of comparing a plurality of objects, a form of questioning the accuracy of a case, and the like, and the field to which the user question belongs, that is, the range of a domain may be vast. In order to automatically provide an appropriate answer to such a user question, various question-answering methods have been studied. However, the proposed question-answering methods may have different characteristics and provide different answers to the same question, respectively. Accordingly, in order to obtain the most appropriate answer to a user question, it may be considered to obtain all answers by various question-answering methods and evaluate the obtained answers, but this may result in an increase in cost, such as time and computational power, and thus provide low efficiencies.

### DESCRIPTION OF EMBODIMENTS

### Technical Problem

The technical idea of the present invention is to provide a system and method for ensemble question-answering with improved efficiency by selecting a question-answering method suitable for a user question from among a plurality of question-answering methods.

### Solution to Problem

In order to achieve the above object, according to an aspect of the technical idea of the present invention, a system for ensemble question-answering may include a user interface that receives a question input from a user and provides an answer output to the user, a deep learning network trained to select at least one question-answering engine suitable for a question from among a plurality of question-answering engines, a model detection unit that provides the question input and semantic data generated by natural language processing of the question input to the deep learning network, and receives at least one index corresponding to at least one question-answering engine from among the plurality of question-answering engines from the deep learning network, and an answer generation unit that provides the question input to the at least one question-answering engine and generates the answer output by receiving an answer from the at least one question-answering engine.

According to an exemplary embodiment of the present invention, the system for ensemble question-answering may further include a deep learning control unit that controls training of the deep learning network based on a sample question, sample semantic data generated by natural language processing of the sample question, and a plurality of sample answers provided by the plurality of question-answering engines to the sample question.

According to an exemplary embodiment of the present invention, the deep learning control unit may obtain vectors corresponding to the sample question, the sample semantic data, and the plurality of sample answers from a word vector model, and provide the vectors to the deep learning network.

According to an exemplary embodiment of the present invention, the deep learning control unit may control the training of the deep learning network based on reinforcement learning, wherein the reinforcement learning may have the vectors as states, may have selecting at least one of the plurality of question-answering engines as an action, and may have whether an answer provided by the at least one selected question-answering engine is correct as a reward.

According to an exemplary embodiment of the present invention, the system for ensemble question-answering may further include a natural language processing unit that generates the semantic data including identifiers of knowledge entities corresponding to tokens included in the question input with reference to a knowledge base.

According to an exemplary embodiment of the present invention, the model detection unit may obtain vectors corresponding to the question input and the semantic data from a word vector model, and may provide the vectors to the deep learning network.

According to an exemplary embodiment of the present invention, the system for ensemble question-answering may further include a natural language generation unit that generates a natural language answer based on an answer provided from the answer generation unit and provides the generated natural language answer to the answer generation unit.

According to an exemplary embodiment of the present invention, the answer generation unit may receive answers by providing a question input to two or more question-answering engines according to at least one index, and may select one answer based on at least one of a time taken for the received answers to be provided, the number of received answers, and a degree of similarity between the received answers.

According to an exemplary embodiment of the present invention, a plurality of question-answering engines may include a search-based engine that provides an answer by searching for a question similar to the question input, a knowledge base-based engine that provides an answer by referencing a knowledge base, and a technical reading-based engine that searches for a document related to the question input and retrieves an answer from the searched document.

According to one aspect of the technical idea of the present invention, a method for ensemble question-answering may include receiving a question input from a user, obtaining semantic data generated by natural language processing of the question input, providing the question input and the semantic data to a trained deep learning network to select at least one question engine suitable for a question from among a plurality of question-answering engines, receiving an answer from at least one question-answering engine corresponding to an index received from the deep learning network, and generating a response output based on the received response and providing the response output to the user.

According to an exemplary embodiment of the present invention, the method for ensemble question-answering may further include, based on reinforcement learning, training the deep learning network using a sample question, sample semantic data generated by natural language processing of the sample question, and a plurality of sample answers provided by the plurality of question-answering engines for the sample question.

### Advantageous Effects of Disclosure

According to a system and a method according to the technical idea of the present invention, high question-answer efficiency can be achieved by omitting execution of all of a plurality of question-answering engines.

In addition, according to the system and method according to the technical idea of the present invention, due to the improved efficiency, fast answer times and low computing capability may be achieved.

Effects that can be obtained in the embodiments of the present invention are not limited to the effects mentioned above, and other effects not mentioned may be clearly derived and understood by those of ordinary skill in the art to which the present invention pertains from the description of the embodiments of the present invention below. In other words, unintended effects of practicing the present invention may also be derived by those of ordinary skill in the art from the embodiments of the present invention.

### BRIEF DESCRIPTION OF DRAWINGS

FIG. 1 is a block diagram illustrating an ensemble question-answering system according to an exemplary embodiment of the present invention.

FIG. 2 is a block diagram illustrating a natural language processing unit according to an exemplary embodiment of the present invention.

FIG. 3 is a block diagram illustrating a model detection unit and a deep learning control unit according to an exemplary embodiment of the present invention.

FIGS. 4A, 4B, and 4C are views illustrating examples of a processing operation for an input question according to exemplary embodiments of the present invention.

FIG. 5 is a block diagram illustrating an operation of a deep learning control unit according to an exemplary embodiment of the present invention.

FIG. 6 is a flowchart illustrating a method for ensemble question-answering according to an exemplary embodiment of the present invention.

FIG. 7 is a flowchart illustrating a method for ensemble question-answering according to an exemplary embodiment of the present invention.

FIG. 8 is a flowchart illustrating a method for ensemble question-answering according to an exemplary embodiment of the present invention.

### MODE OF DISCLOSURE

Hereinafter, embodiments of the present invention will be described in detail with reference to the accompanying drawings. Embodiments of the present invention are provided so that the present invention will be thorough and complete, and will fully convey the concept of the present invention to those of ordinary skill in the art. Since the present invention may have diverse modified embodiments, preferred embodiments are illustrated in the drawings and are described in the detailed description. However, this does not limit the present invention within specific embodiments and it should be understood that the present invention covers all the modifications, equivalents, and replacements within the idea and technical scope of the present invention. Like reference numerals refer to like elements throughout. In the drawings, the dimensions and size of each structure are exaggerated, reduced, or schematically illustrated for convenience in description and clarity.

The terms used in this application, only certain embodiments have been used to describe, is not intended to limit the present invention. As used herein, the singular forms “a,” “an,” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by those of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the drawings and description below, a component indicated or described as one block may be a hardware block or a software block. For example, components may be independent hardware blocks that send and receive signals to and from each other, or may be software blocks executed by at least one processor. A software block may include a series of instructions executable by at least one processor and/or source code from which such instructions may be generated through compilation, and may be stored in a computer-readable non-transitory storage medium, such as an optical storage medium (e.g., CD, DVD, etc.), a semiconductor memory device (e.g., a flash memory, EPROM, etc.), and a magnetic disk device (e.g., a hard disk drive, a magnetic tape, etc.). In addition, as used herein, “system” or “database” may refer to a computing system including at least one processor and memory accessed by the processor.

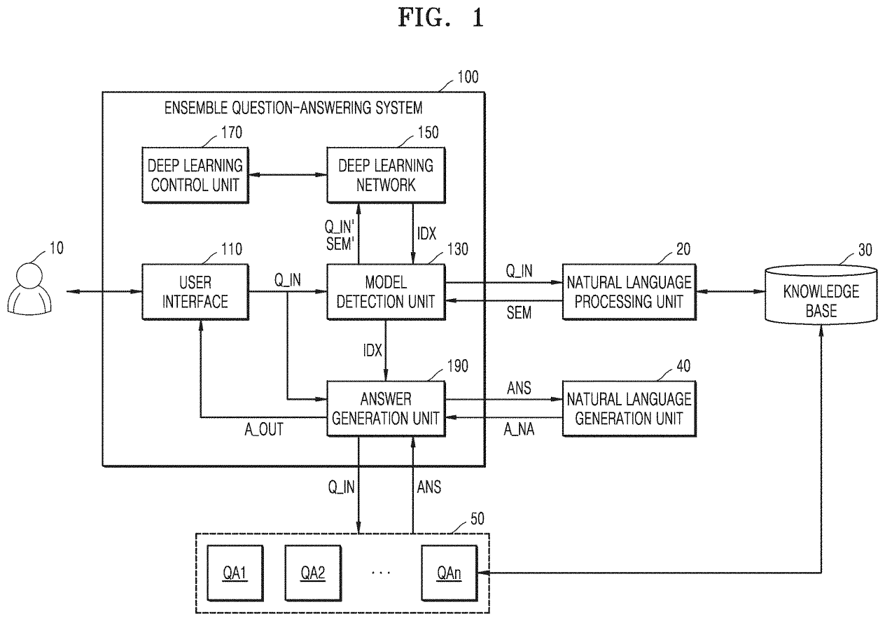

FIG. 1 is a block diagram illustrating an ensemble question-answering system 100 according to an exemplary embodiment of the present invention. In more detail, the block diagram of FIG. 1 shows the ensemble question-answering system 100 and systems in communication with the ensemble question-answering system 100 together. As shown in FIG. 1, the ensemble question-answering system 100 may receive a question from a user 10, and may provide an answer to the question to the user 10.

The user 10 may refer to any target that may provide a question input Q_IN to the ensemble question-answering system 100 by voice or text and receive an answer output A_OUT from the ensemble question-answering system 100 in voice or text. For example, the user 10 may refer to any terminal that communicates with the ensemble question-answering system 100 through a communication channel, and the terminal transmits the question input Q_IN to the ensemble question-answering system 100 through the communication channel according to a message input from a user of the terminal, or may provide the answer output A_OUT received from the ensemble question-answering system 100 to the user of the terminal in a manner such as an audio output or display. In some embodiments, the communication channel between the user 10 and the ensemble question-answering system 100 may be formed via a network such as the Internet, or may be one-to-one direct communication such as communication between a kiosk and a terminal.

As shown in FIG. 1, the ensemble question-answering system 100 may communicate with the user 10, a natural language processing unit 20, a natural language generation unit 40, and a question-answering engine group 50. The ensemble question-answering system 100 may include a user interface 110, a model detection unit 130, a deep learning network 150, a deep learning control unit 170, and an answer generation unit 190. In some embodiments, unlike shown in FIG. 1, the ensemble question-answering system 100 may include at least one of the natural language processing unit 20, the natural language generation unit 40, and the question-answering engine group 50, and may include a knowledge base 30 communicating with the natural language processing unit 20.

The user interface 110 may form a communication channel with the user 10. The user interface 110 may provide the question input Q_IN received from the user 10 through the communication channel to the model detection unit 130, and may provide the answer output A_OUT provided from the answer generation unit 190 to the user 10 through the communication channel. In some embodiments, the question input Q_IN may include a natural language question, and the answer output A_OUT may include a natural language answer.

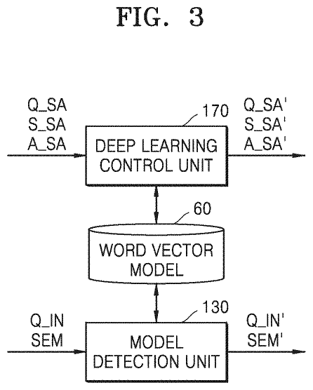

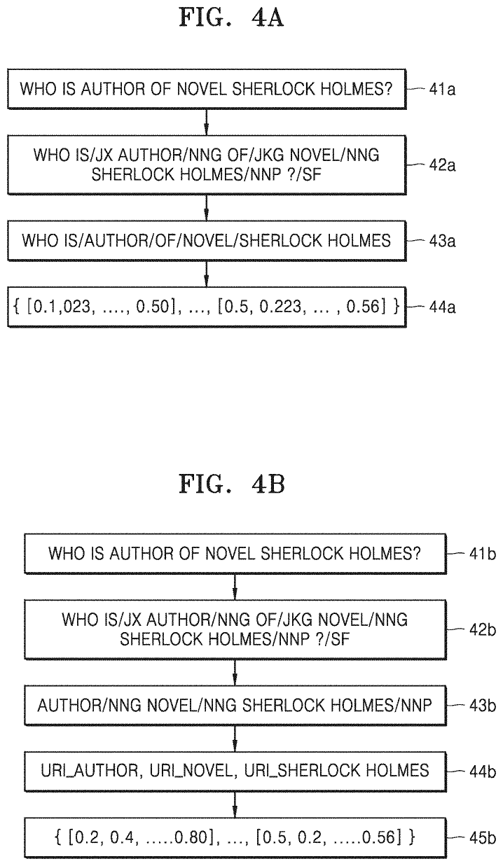

The model detection unit 130 may communicate with the deep learning network 150 to select at least one question-answering engine suitable for the question input Q_IN from among first to n^{th} question-answering engines QA1 to QAn (n is an integer greater than 1) included in the question-answering engine group 50. For example, the model detection unit 130 may provide a question input vector Q_IN′ and a semantic vector SEM′ generated from the question input Q_IN received from the user interface 110 to the deep learning network 150, and may receive an index IDX indicating at least one of the first to n^{th} question-answering engines QA1 to QAn included in the question-answering engine group 50 from the deep learning network 150. In some embodiments, the model detection unit 130 may receive a score list including scores of the first to n^{th} question-answering engines QA1 to QAn from the deep learning network 150. As will be described later with reference to FIGS. 3 and 4A and 4B, the question input vector Q_IN′ may include vectors corresponding to tokens included in the question input Q_IN, and the semantic vector SEM′ may include vectors corresponding to knowledge entities included in semantic data SEM generated by natural language processing of the question input Q_IN.

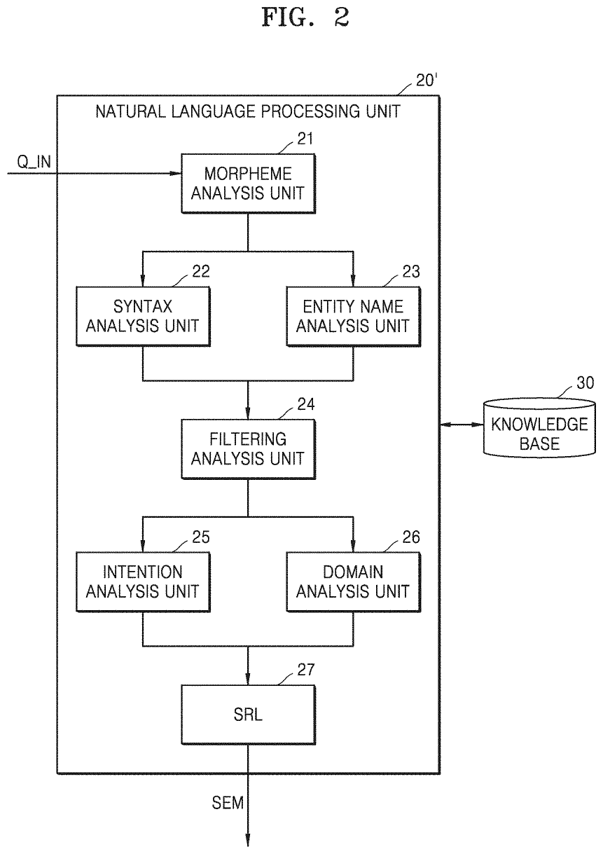

The model detection unit 130 may provide the question input Q_IN to the natural language processing unit 20 to obtain the semantic data SEM, and the natural language processing unit 20 may generate the semantic data SEM from the question input Q_IN with reference to the knowledge base 30. For example, the natural language processing unit 20 may detect knowledge entities corresponding to tokens included in the question input Q_IN from the knowledge base 30 and generate the semantic data SEM including identifiers of the knowledge entities. An example of the natural language processing unit 20 will be described later with reference to FIG. 2. The model detection unit 130 may provide the index IDX received from the deep learning network 150 to the answer generation unit 190.

The deep learning network 150 may be a state trained by the deep learning control unit 170 to select at least one question-answering engine suitable for a question from among the first to n^{th} question-answering engines QA1 to QAn included in the question-answering engine group 50. Accordingly, the deep learning network 150 may output the index IDX indicating at least one question-answering engine that provides an appropriate answer to the question input Q_IN based on the question input vector Q_IN′ and the semantic vector SEM′ derived from the question input Q_IN. In some embodiments, the deep learning network 150 may output a score list including scores indicating the degree to which answers provided by the first to n^{th} question-answering engines QA1 to QAn are suitable for the question input Q_IN. The deep learning network 150 may have any structure, may be implemented as, for example, hardware or a combination of hardware and software, and may be referred to as an artificial neural network ANN. The deep learning network 150 may include, as non-limiting examples, a Deep Neural Network (DNN), a Convolution Neural Network (CNN), a Recurrent Neural Network (RNN), a Restricted Boltzmann Machine (RBM), a Deep Belief Network (DBN), and a Deep Q-Network.

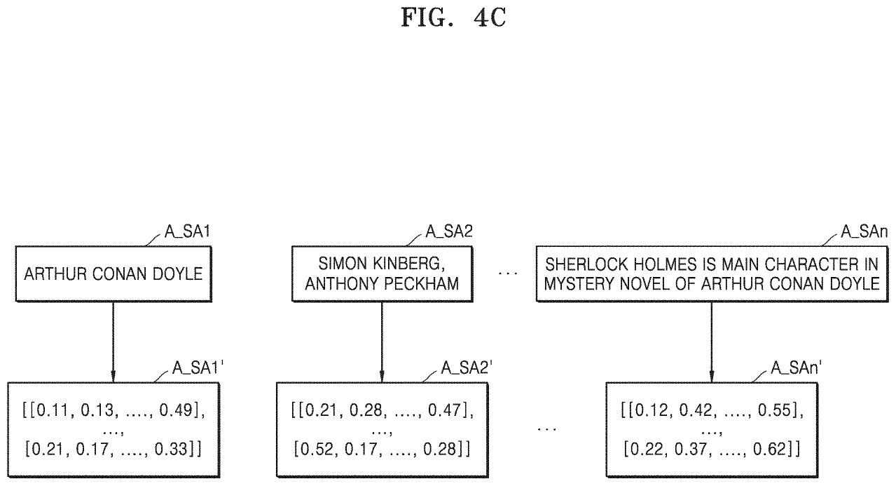

The deep learning control unit 170 may control training of the deep learning network 150. For example, the deep learning control unit 170 may train the deep learning network 150 based on a sample question, sample semantic data generated by natural language processing of the sample question, a plurality of sample answers provided by the first to n^{th} question-answering engines QA1 to QAn with respect to the sample question. In some embodiments, the deep learning control unit 170 may control training of the deep learning network 150 based on reinforcement learning RL. An example of a training operation by the deep learning control unit 170 will be described later with reference to FIG. 5.

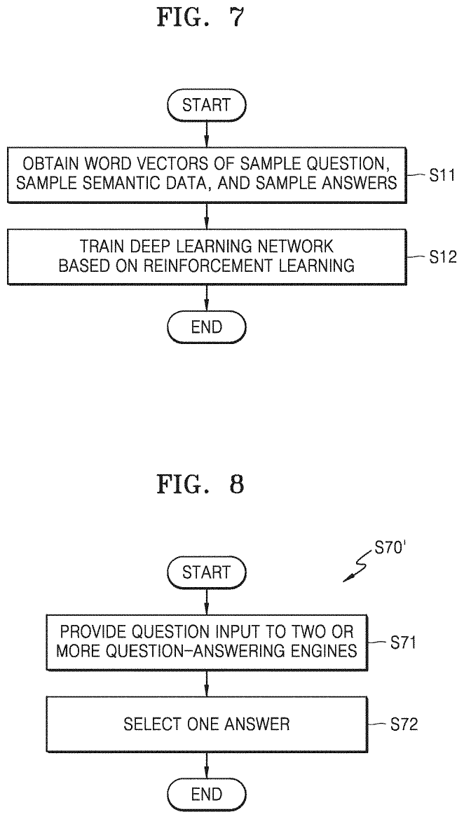

The answer generation unit 190 may receive the index IDX from the model detection unit 130, may provide the question input Q_IN to at least one of the first to n^{th} question-answering engines QA1 to QAn based on the index IDX, and may receive an answer ANS from the at least one question-answering engine. In some embodiments, the answer generation unit 190 may provide the semantic data SEM to at least one of the first to n^{th} question-answering engines QA1 to QAn in place of or together with the question input Q_IN. In addition, the answer generation unit 190 may provide the answer ANS to the natural language generation unit 40, and may receive a natural language answer A_NA generated from the answer ANS by the natural language generation unit 40. The answer generation unit 190 may generate the answer output A_OUT from the natural language answer A_NA and provide the answer output A_OUT to the user 10 through the user interface 110. In some embodiments, the natural language generation unit 40 may be omitted, and the answer generation unit 190 may generate the answer output A_OUT including, for example, a short-type answer based on the answer ANS. An example of the operation of the answer generation unit 190 will be described later with reference to FIG. 8.

The first to n^{th} question-answering engines QA1 to QAn may be implemented according to different question-answering methods, respectively, and thus may have different characteristics. For example, the first question-answering engine QA1 may be a search-based engine that searches for a question similar to a question input in a document composed of a question-answer pair and provides an answer corresponding thereto. Accordingly, the first question-answering engine QA1 may easily search for an answer when a question input similar to the question in a document occurs, while it may be difficult to provide a valid answer when the form of a sentence included in the question, for example, a word order or expression method is changed. The second question-answering engine QA2 may be a technical reading-based question-answering engine configured to search for a document related to a question based on, for example, a deep learning technique, and retrieve an answer from the searched document. Accordingly, the second question-answering engine QA2 may respond to a question having a relatively complex structure, while a large amount of questions and documents may be required for machine reading. The n^{th} question-answering engine QAn may be a knowledge base-based question-answering engine configured to provide answers with reference to the knowledge base 30. Accordingly, the n^{th} question-answering engine QAn may provide a more accurate answer and an answer through reasoning is possible because the n^{th} question-answering engine QAn is based on not only the form of a sentence but also a semantic analysis, while the n^{th} question-answering engine QAn may have a performance dependent on the construction of a useful knowledge base 30.

Due to different characteristics of the first to n^{th} question-answering engines QA1 to QAn, it may be difficult for one question-answering engine to provide optimal answers to all questions. Accordingly, a structure that generates the answer output A_OUT based on a question-answering engine that provides the most appropriate answer to the question input Q_IN from among a number of question-answering engines, that is, the first to n^{th} question-answering engines QA1 to QAn may be required, and this structure may be referred to as ensemble question-answering.

For ensemble question-answering, an answer evaluation method of providing the question input Q_IN to all of the first to n^{th} question-answering engines QA1 to QAn and finally determining an answer by evaluating (or by ranking) answers received from the first to n^{th} question-answering engines QA1 to QAn may be considered. However, such an answer evaluation method not only takes a lot of time, but may also require many resources for executing all of the first to n^{th} question-answering engines QA1 to QAn. On the other hand, the ensemble question-answering system 100 of FIG. 1 may select at least one question-answering engine most suitable for the question input Q_IN from among the first to n^{th} question-answering engines QA1 to QAn, and may generate the answer output A_OUT based on an answer by the at least one selected question-answering engine, thereby achieving high-efficiency ensemble question-answering.

FIG. 2 is a block diagram illustrating a natural language processing unit 20′ according to an exemplary embodiment of the present invention. As described above with reference to FIG. 1, the natural language processing unit 20′ may receive the question input Q_IN and generate the semantic data SEM from the question input Q_IN with reference to the knowledge base 30. Like the “natural language understanding unit” described in Korean Patent Application No. 10-2018-0150093, filed by the same applicant as the applicant of the present application and incorporated herein by reference in its entirety, the natural language processing unit 20′ of FIG. 2 may include a morpheme analysis unit 21, a syntax analysis unit 22, an entity name analysis unit 23, a filtering analysis unit 24, an intention analysis unit 25, a domain analysis unit 26, and a semantic role labeling (SRL) unit 27. In the description of FIG. 2, the content overlapping with the content of the “natural language understanding unit” described in Korean Patent Application No. 10-2018-0150093 will be omitted. In addition, the natural language processing unit 20′ of FIG. 2 is only an example of the natural language processing unit 20 of FIG. 1, and it will be understood that the natural language processing unit 20 of FIG. 1 may have a different structure from that of the natural language processing unit 20′ of FIG. 2.

The morpheme analysis unit 21 may receive the question input Q_IN. The morpheme analysis unit 21 may divide a word, that is, a unit divided based on spacing, into morpheme units, and a morpheme may refer to a unit obtained by dividing a word into meaningful units. For example, the word “in Korean” may be divided into the morpheme “Korean (noun)” and the morpheme “in (proposition)” by the morpheme analysis unit 21.

The syntax analysis unit 22 may analyze a structure of a sentence by decomposing the sentence into constituent elements forming the sentence, and analyzing a relationship between the decomposed constituent elements. For example, tokens included in a sentence may be classified into one of phrases such as idioms, adverbs, adjectives, exclamations, adjectives, etc., and each of the phrases may function as a conjunction, adjective modifier, object, verb modifier, independent word, subject, complement, and the like.

The entity name analysis unit 23 may determine a category of a specific meaning encompassing a morpheme (e.g., nouns), for example, a person, a company, a place name, a region, a movie, a date, a time, and the like. For example, the morpheme “Seoul (noun)” may be included in the category “region”. To this end, the entity name analysis unit 23 may refer to knowledge data included in the knowledge base 30.

The filtering analysis unit 24 may generate a simplified question pattern by removing some of the morphemes divided by the morpheme analysis unit 21. For example, the filtering analysis unit 24 may generate a simplified question pattern by removing a morpheme corresponding to a postposition from among morphemes divided from the question input Q_IN.

The intention analysis unit 25 may analyze meaning and intention of the question input Q_IN. For example, when “How's the weather in Seoul tomorrow?” is received by the natural language processing unit 20′ as the question input Q_IN, and the intention analysis unit 25 may analyze an intention such as “asking the weather” based on the simplified question pattern provided from the filtering analysis unit 24.

The domain analysis unit 26 may analyze a field to which the question input Q_IN belongs, that is, a domain. For example, the domain analysis unit 26 may detect at least one of a plurality of domains such as finance, medical care, IT, politics, common sense, and the like, based on the simplified question pattern provided from the filtering analysis unit 24.

A semantic role-labeling unit 27 may map the above analyzed tokens with knowledge included in the knowledge base 30. For example, the semantic role labeling unit 27 may determine knowledge corresponding to a token included in the question input Q_IN in the knowledge base 30 based on results of morphological analysis, syntax analysis, filtering analysis, intent analysis, and domain analysis of the question input Q_IN, and may map the token to the corresponding knowledge by giving the knowledge, that is, a unique identifier of a knowledge entity, to the token. The unique identifier of the knowledge entity may be, for example, a Uniform Resource Identifier (URI). Accordingly, the semantic data SEM may include identifiers of knowledge entities of tokens included in the question input Q_IN.

FIG. 3 is a block diagram illustrating the model detection unit 130 and the deep learning control unit 170 according to an exemplary embodiment of the present invention. In more detail, the block diagram of FIG. 3 shows an example of an operation in which the model detection unit 130 and the deep learning control unit 170 generate word vectors with reference to a word vector model 60. As described above with reference to FIG. 1, the model detection unit 130 may select at least one question-answering engine by communicating with the deep learning network 150 of FIG. 1, and the deep learning control unit 170 may control training of the deep learning network 150 of FIG. 1. Hereinafter, FIG. 3 will be described with reference to FIG. 1.

The word vector model 60 may refer to a multidimensional space in which a meaningful word (or token) is expressed by one coordinate, that is, a word vector, or a system including word vectors and updating the word vectors. Semantically similar words may be disposed adjacent to each other in a multidimensional space, and thus, word vectors corresponding to the semantically similar words may have similar values. As described above, in order for the deep learning network 150 to select a question-answering engine suitable for a question, the deep learning network 150 may receive word vectors corresponding to tokens each having a meaning. In some embodiments, the ensemble question-answering system 100 of FIG. 1 may include the word vector model 60, and in some embodiments, the deep learning control unit 170 and the model detection unit 130 may access the word vector model 60 outside the ensemble question-answering system 100 of FIG. 1.

The deep learning control unit 170 may receive a sample question Q_SA, sample semantic data S_SA generated by natural language processing of the sample question Q_SA, and sample answers A_SA of the first to n^{th} question-answering engines QA1 to QAn to the sample question Q_SA, and may output a sample question vector Q_SA′, a sample semantic vector S_SA′, and sample answer vectors A_SA′ respectively corresponding to the sample question Q_SA, the sample semantic data S_SA, and the sample answers A_SA with reference to the word vector model 60. The deep learning control unit 170 may control training of the deep learning network 150 by providing the sample question vector Q_SA′, the sample semantic vector S_SA′, and the sample answer vectors A_SA′ to the deep learning network 150, and an example of this will be described later with reference to FIG. 5. In some embodiments, the sample question Q_SA, the sample semantic data S_SA, and the sample answers A_SA may be prepared in advance for training of the deep learning network 150, and in some embodiments, the sample semantic data S_SA and the sample answers A_SA may be generated by the natural language processing unit 20 and the question-answering engine group 50 from the sample question Q_SA in a training process.

The model detection unit 130 may receive the question input Q_IN and the semantic data SEM, and may output the question input vector Q_IN′ and the semantic data SEM′ respectively corresponding to the question input Q_IN and the semantic data SEM with reference to the word vector model 60. The model detection unit 130 may receive the index IDX indicating at least one question-answering engine from the deep learning network 150 by providing the question input vector Q_IN′ and the semantic vector SEM′ to the deep learning network 150. In some embodiments, to generate the question input vector Q_IN′ from the question input Q_IN, the model detection unit 130 may receive the result of performing morpheme analysis, syntax analysis, entity name analysis, and filtering analysis on the question input Q_IN from the natural language generation unit 40 of FIG. 1.

FIGS. 4A, 4B, and 4C are views illustrating examples of a processing operation for an input question according to exemplary embodiments of the present invention. In more detail, FIG. 4A shows an example in which the sample question vector Q_SA′ and/or the question input vector Q_IN′ is generated, FIG. 4B shows an example in which the sample semantic vector S_SA′ and/or the semantic vector SEM′ is generated, and FIG. 4C shows an example in which the sample answer vectors A_SA′ are generated. Hereinafter, FIGS. 4A and 4B will be described with reference to the question input Q_IN and the semantic data SEM generated therefrom, but it will be understood that this may be similarly applied to the sample question Q_SA and the sample semantic data S_SA. Hereinafter, redundant content in the description of FIGS. 4A, 4B and 4C will be omitted, and FIGS. 4A, 4B and 4C will be described with reference to FIG. 1.

Referring to FIG. 4A, “Who is the author of the novel Sherlock Holmes?” may be provided as the question input Q_IN (41a), and the question input Q_IN may be transmitted to the natural language processing unit 20 by the model detection unit 130. As described above with reference to FIG. 2, the natural language processing unit 20 may perform morpheme analysis, syntax analysis, entity name analysis, and filtering analysis on the question input Q_IN, and tokens included in the question input Q_IN may be analyzed. Accordingly, tags indicating a morpheme, a syntax, etc. may be added to the tokens of the question input Q_IN (42a). Then, the model detection unit 130 may remove a tag and a symbol (43a), and generate word vectors, that is, the question input vector Q_IN′, with reference to the word vector model 60 (44a).

Referring to FIG. 4B, “Who is the author of the novel Sherlock Holmes?” may be provided as the question input Q_IN (41b), and the question input Q_IN may be transmitted to the natural language processing unit 20 by the model detection unit 130. As described above with reference to FIG. 2, the natural language processing unit 20 may perform morpheme analysis, syntax analysis, entity name analysis, and filtering analysis on the question input Q_IN, and tokens included in the question input Q_IN may be analyzed. Accordingly, tags indicating a morpheme, a syntax, etc. may be added to the tokens of the question input Q_IN (42b). Then, the natural language processing unit 20 may remove a proposition and a symbol (43b), and may obtain a unique identifier of a knowledge entity corresponding to a token, for example, a URI by searching the knowledge base 30 (44b). The model detection unit 130 may receive the semantic data SEM including URIs corresponding to tokens from the natural language processing unit 20, and may generate word vectors, that is, the semantic vector SEM′, with reference to the word vector model 60 (45b). In some embodiments, a knowledge entity of the knowledge base 30 may contain its own word vector, and the model detection unit 130 may obtain a word vector by using a URI corresponding to a token.

Referring to FIG. 4C, for “Who is the author of the novel Sherlock Holmes?” as the sample question Q_SA, answers may be generated from a plurality of question-answering engines. For example, as shown in FIG. 4C, “Arthur Conan Doyle” may be obtained as a first sample answer A_SA1, “Simon Kinberg, Anthony Peckham” may be obtained as a second sample answer A_SA2, and “Sherlock Holmes is the main character in the mystery novel of Arthur Conan Doyle” may be obtained as an n^{th} sample answer A_SAn. The deep learning control unit 170 may generate, with reference to the word vector model 60, a first sample answer vector A_SA1′, a second sample answer vector A_SA2′, and an n^{th} sample answer vector A_SAn′ respectively corresponding to the first sample answer A_SA1, the second sample answer A_SA2, and the n^{th} sample answer A_SAn.

FIG. 5 is a block diagram illustrating an operation of a deep learning control unit according to an exemplary embodiment of the present invention. As described above with reference to FIGS. 1 and 3, the deep learning control unit 170 may control training of the deep learning network 150 using the sample question vector Q_SA′, the sample semantic vector S_SA′, and the sample answer vectors A_SA′. Hereinafter, FIG. 5 will be described with reference to FIGS. 1 and 3.

The deep learning control unit 170 may control training of the deep learning network 150 based on the reinforcement learning RL. Because reinforcement learning is not performed based on fixed data, the reinforcement learning has the characteristic of autonomously learning through experience on its own without a large amount of data and accurate labels for the data. The deep learning control unit 170 receives the sample question Q_SA and a natural language understanding result for the sample question Q_SA, that is, the sample semantic data S_SA, as an input and causes the deep learning network 150 to output the index IDX indicating a selected question-answering engine, and may provide a reward RWD depending on whether the index IDX represents an appropriate question-answering engine.

The reinforcement learning may refer to training an agent defined in the environment to recognize a current state and select an action or action sequence that maximizes a reward from among selectable actions. Here, the agent may refer to a target capable of taking an action, the action may refer to any action that the agent can take, and the environment may refer to the world in which the agent may act. The state may refer to an agent's situation when taking an action, and the reward may refer to feedback that measures the success or failure of an agent's action. Policy may refer to a strategy used to determine the next action based on the current state, and the agent may choose actions that maximize rewards in a particular state.

Referring to FIG. 5, the deep learning control unit 170 may implement a state STA, an agent AGE, and an environment ENV of FIG. 5 for reinforcement learning of the deep learning network 150. The state STA may be the sample question vector Q_SA′, the sample semantic vector S_SA′, and the sample answer vectors A_SA′, the action may be selecting at least one of a plurality of question-answering engines, that is, the output of the index IDX, the reward RWD may be +1 if the answer performed by the selected question-answering engine is correct, and −1 otherwise, and the environment ENV may observe the state STA. In some embodiments, the deep learning control unit 170 may adjust the reward based on a discount factor in order to reflect the importance according to a time-step.

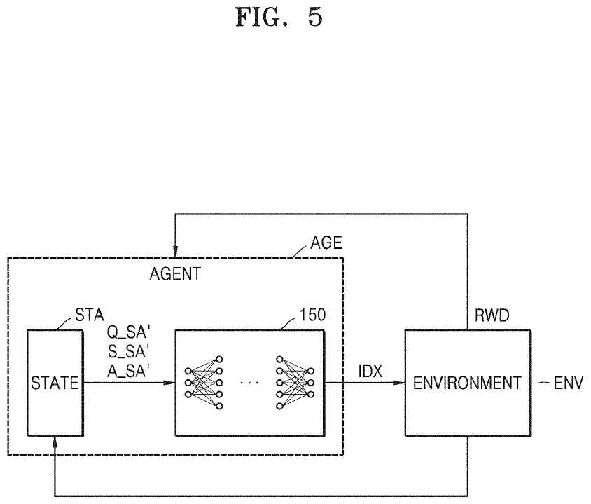

FIG. 6 is a flowchart illustrating a method for ensemble question-answering according to an exemplary embodiment of the present invention. In some embodiments, the method of FIG. 6 may be performed by the ensemble question-answering system 100 of FIG. 1. As shown in FIG. 6, the method for ensemble question-answering may include a plurality of operations (S20 to S70). Hereinafter, FIG. 6 will be described with reference to FIG. 1.

In operation S20, the question input Q_IN may be received. For example, the question input Q_IN may be received from the user 10 through the user interface 110. Then, in operation S30, the semantic data SEM of the question input Q_IN may be obtained. For example, the model detection unit 130 may provide the question input Q_IN to the natural language processing unit 20, and the natural language processing unit 20 may generate the semantic data SEM generated by natural language processing of the question input Q_IN with reference to the knowledge base 30.

In operation S40, the question input Q_IN and the semantic data SEM may be provided to the deep learning network 150. For example, the model detection unit 130 may provide the question input vector Q_IN′ and the semantic vector SEM′ generated from the question input Q_IN and the semantic data SEM to the deep learning network 150. Then, in operation S50, the index IDX of the question-answering engine may be obtained. For example, the model detection unit 130 may receive the index IDX indicating at least one question-answering engine from the deep learning network 150.

In operation S60, the question input Q_IN may be provided and the answer ANS may be received. For example, the answer generation unit 190 may provide the question input Q_IN to a question-answering engine QAx corresponding to the index IDX, and receive the answer ANS from the question-answering engine QAx. Then, in operation S70, an answer output Q_OUT may be generated. For example, the answer generation unit 190 may generate an answer output Q_OUT based on the answer ANS received in operation S60, and the answer output Q_OUT may be provided to the user 10 through the user interface 110. An example of operation S70 will be described later with reference to FIG. 8.

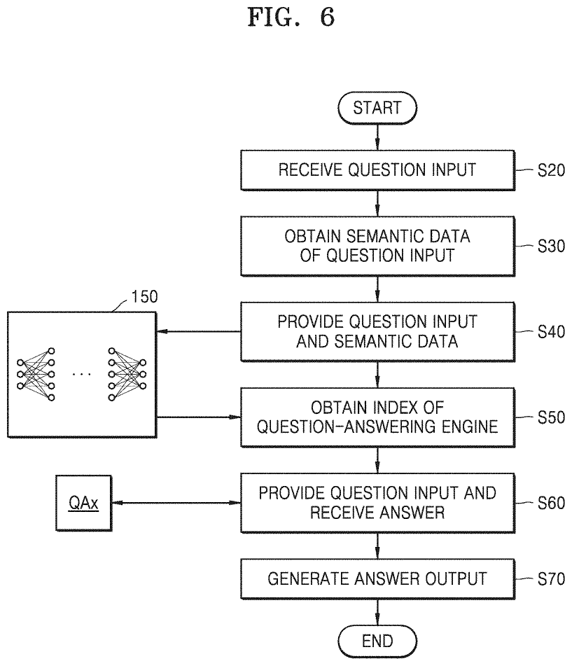

FIG. 7 is a flowchart illustrating a method for ensemble question-answering according to an exemplary embodiment of the present invention. In more detail, the flowchart of FIG. 7 shows a method of training the deep learning network 150 of FIG. 1 to select a question-answering engine suitable for a question from among a plurality of question-answering engines. In some embodiments, the method of FIG. 7 may be performed before operation S20 of FIG. 6 is performed, may be repeatedly performed, and may be performed by the deep learning control unit 170 of FIG. 1. As shown in FIG. 7, the method for training the deep learning network 150 may include operations S11 and S12, and FIG. 7 will be described below with reference to FIGS. 3 and 5.

In operation S11, word vectors of the sample question Q_SA, the sample semantic data S_SA, and the sample answers A_SA may be obtained. For example, the deep learning control unit 170, with reference to the word vector model 60, may generate the sample question vector Q_SA′, the sample semantic vector S_SA′, and the sample answer vectors A_SA′ respectively corresponding to the sample question Q_SA, the sample semantic data S_SA, and the sample answers A_SA.

In operation S12, the deep learning network 150 based on reinforcement learning may be trained. For example, as described above with reference to FIG. 5, the deep learning control unit 170 may implement an agent, a state, and an environment for reinforcement learning of the deep learning network 150, and may train the deep learning network 150 by providing the reward RWD based on the index IDX output from the deep learning network 150 in answer to an input, that is, the sample question vector Q_SA′, the sample semantic vector S_SA′, and the sample answer vectors A_SA′.

FIG. 8 is a flowchart illustrating a method for ensemble question-answering according to an exemplary embodiment of the present invention. In more detail, the flowchart of FIG. 8 shows an example of operation S70 of FIG. 6. As described above with reference to FIG. 6, in operation S70′ of FIG. 8, the answer output Q_OUT may be generated. As shown in FIG. 8, operation S70′ may include operations S71 and S72, and FIG. 8 will be described below with reference to FIG. 1.

In operation S71, the question input Q_IN may be provided to two or more question-answering engines. In some embodiments, the deep learning network 150 may provide the index IDX indicating two or more question-answering engines to the model detection unit 130. For example, the deep learning network 150 may provide the model detection unit 130 with the index IDX including ranking information indicating an order suitable for the question input Q_IN with respect to the first to n^{th} question-answering engines QA1 to QAn of FIG. 1. The model detection unit 130 may select a predetermined number of two or more higher-order question-answering engines from the top based on the index IDX, and the answer generation unit 190 may provide the question input Q_IN to the two or more selected question-answering engines. In some embodiments, as described above with reference to FIG. 1, the answer generation unit 190 may provide not only the question input Q_IN but also the semantic data SEM generated from the question input Q_IN to two or more question-answering engines.

In operation S72, one answer may be selected. For example, the answer generation unit 190 may select one of answers provided from two or more question-answering engines. In some embodiments, the answer generation unit 190 may select one answer based on at least one of a time it takes for an answer to be provided from a question-answering engine, the number of answers provided from the question-answering engine, and the degree of similarity between received answers. For example, the answer generation unit 190 may select an answer received within a predefined time, and may stop an operation for generating an answer with respect to a question-answering engine that exceeds the time. In addition, the answer generation unit 190 may exclude a question-answering engine that provides more than a predetermined number of answers. In addition, the answer generation unit 190 may calculate mutual similarities between a plurality of answers with reference to, for example, the word vector model 60 of FIG. 3 and/or the knowledge base 30 of FIG. 1, respectively, and may select one of the answers having a similarity greater than or equal to a predefined criterion based on, for example, ranking of the index IDX and the similarity to the question input Q_IN. In addition, the answer generation unit 190 may select one answer according to exemplified operations of the “answer determination unit” described in Korean Patent Application No. 10-2017-0012965, filed by the same applicant as the applicant of the present application and incorporated herein by reference in its entirety.

Exemplary embodiments have been illustrated and described in the drawings and the detailed description as described above. Although the specific terms are used to explain these embodiments in the present invention, the specific terms are not intended to restrict the scope of the present invention and are only used for a better understanding of the present invention. It will be understood by those of ordinary skill in the art that various changes in form and details may be made without departing from the spirit and scope of the invention as defined by the appended claims. Therefore, the scope of the present invention is defined not by the detailed description of the present invention but by the appended claims.

1. A system for ensemble question-answering, the system comprising:
a user interface configured to receive a question input from a user and provide an answer output to the user;
a deep learning network trained to select at least one question-answering engine suitable for a question from among a plurality of question-answering engines;
a model detection unit configured to provide the question input and semantic data generated by natural language processing of the question input to the deep learning network, and receive at least one index corresponding to at least one question-answering engine from among the plurality of question-answering engines from the deep learning network; and
an answer generation unit configured to provide the question input to the at least one question-answering engine and generate the answer output by receiving an answer from the at least one question-answering engine.

2. The system of claim 1, further comprising:
a deep learning control unit configured to control training of the deep learning network based on a sample question, sample semantic data generated by natural language processing of the sample question, and a plurality of sample answers provided by the plurality of question-answering engines to the sample question.

3. The system of claim 2, wherein the deep learning control unit is configured to obtain vectors corresponding to the sample question, the sample semantic data, and the plurality of sample answers from a word vector model, and provide the vectors to the deep learning network.

4. The system of claim 3, wherein the deep learning control unit is configured to control the training of the deep learning network based on reinforcement learning,
wherein the reinforcement learning has the vectors as states, has selecting at least one of the plurality of question-answering engines as an action, and has whether an answer provided by the at least one selected question-answering engine is correct as a reward.

5. The system of claim 1, further comprising:
a natural language processing unit configured to generate the semantic data including identifiers of knowledge entities corresponding to tokens included in the question input with reference to a knowledge base.

6. The system of claim 1, wherein the model detection unit is configured to obtain vectors corresponding to the question input and the semantic data from a word vector model, and provide the vectors to the deep learning network.

7. The system of claim 1, further comprising:
a natural language generation unit configured to generate a natural language answer based on an answer provided from the answer generation unit and provide the generated natural language answer to the answer generation unit.

8. The system of claim 1, wherein the answer generation unit is configured to receive answers by providing the question input to two or more question-answering engines according to at least one index, and select one answer based on at least one of a time taken for the received answers to be provided, the number of received answers, and a degree of similarity between the received answers.

9. The system of claim 1, wherein the plurality of question-answering engines comprise:
a search-based engine configured to provide an answer by searching for a question similar to the question input;
a knowledge base-based engine configured to provide an answer by referencing a knowledge base; and
a technical reading-based engine configured to search for a document related to the question input and search for an answer from the searched document.

10. A method for ensemble question-answering, the method comprising:
receiving a question input from a user;
obtaining semantic data generated by natural language processing of the question input;
providing the question input and the semantic data to a trained deep learning network to select at least one question engine suitable for a question from among a plurality of question-answering engines;
receiving an answer from at least one question-answering engine corresponding to an index received from the deep learning network; and
generating a response output based on the received response and providing the response output to the user.

11. The method of claim 10, further comprising:
training the deep learning network using a sample question, sample semantic data generated by natural language processing of the sample question, and a plurality of sample answers provided by the plurality of question-answering engines for the sample question, based on reinforcement learning.
